(19) United States
(12) Patent Application Publication
(10) Pub. No.: US 2012/0300137 A1
(43) Pub. Date: Nov. 29, 2012

(54) LIGHTING DEVICE, DISPLAY DEVICE AND TELEVISION RECEIVER

(75) Inventor: Nobuhiro Kasai, Osaka-shi (JP)

(73) Assignee: SHARP KABUSHIKI KAISHA, Osaka-shi, Osaka (JP)

(21) Appl. No.: 13/519,635

(22) PCT Filed: Dec. 7, 2010
(86) PCT No.: PCT/JP2010/071887

§ 371 Date: Jun. 28, 2012

(30) Foreign Application Priority Data
Jan. 18, 2010 (JP) 2010-008198

(51) Int. Cl. F21V 8/00; G02F 1/13357; H04N 5/66; G21K 5/00

(52) U.S. Cl. 348/739; 362/611; 362/612; 250/504 R; 349/62; 348/E05.133

(57) ABSTRACT

A lighting device of higher heat radiation performance is provided. A lighting device 21 includes: a light guide plate 31 having an end surface 33 as a light entrance surface; a base 40 having an attachment surface 41 that faces the end surface 33 of the light guide plate 31; an LED board 35 having a light emitting surface and provided on the attachment surface 41 such that the light emitting surface faces the end surface 33 of the light guide plate 31; and a pair of heat conduction walls 42 and 43 each arranged on either side of the LED board 35 on the attachment surface 41 of the base 40 and conducting heat generated from the LED board 35 to the base 40. In the lighting device 21, the heat generated form the LED board 35 is conducted to the base side via the heat conduction walls 42 and 43 to be radiated. This enhances heat radiation performance of the LED board 35 that is a heat generation source.

### TECHNICAL FIELD

The present invention relates to a lighting device, a display device and a television receiver.

### BACKGROUND ART

As a lighting device used in a display device such as a liquid crystal panel, there is a so-called edge-light-type lighting device that makes illumination light incident from an end surface of a light guide plate. Patent Document 1 discloses a technique of enhancing radiation performance of LEDs by dividing LEDs of light sources into two or more groups and providing the dedicated wiring board to each group in this kind of a lighting device.

Patent Document 1: Japanese Unexamined Patent Publication No. 2009-37212

### PROBLEM TO BE SOLVED BY THE INVENTION

In recent years, a liquid crystal panel has been significantly large and, according to this, the total amount of heat generated from a light source tends to increase. Consequently, if heat generated from a light source is not completely radiated, the temperature increases, which may decrease luminance efficiency or thermally degrade the light source. Therefore, it is desired to enhance radiation performance.

### DISCLOSURE OF THE PRESENT INVENTION

The present invention was made in view of the foregoing circumstances. It is an object of the present invention to provide a lighting device of higher radiation performance. Further, it is an object to provide a display device having such a lighting device, and further a television receiver having such a display device.

### MEANS FOR SOLVING THE PROBLEM

A lighting device of the present technology includes a light guide plate having an end surface as a light entrance surface, a base having an attachment surface and provided such that the attachment surface faces the end surface of the light guide plate, a light source having a light emitting surface and provided on the attachment surface of the base such that the light emitting surface faces the end surface of the light guide plate, and a pair of heat conduction walls each of which is provided on either side of the light source and on the attachment surface of the base and configured to conduct heat generated from the light source to the base.

With the above lighting device, the heat generated from the light source is conducted to the base side via the heat conduction walls and radiated. This enhances heat radiation performance of the light source of a heat generation source.

As an embodiment of the lighting device according to the present technology, the following configurations are preferable.

Each of the heat conduction walls may project from the base toward the light guide plate such that an end of each heat conduction walls is located far from the light source and the heat conduction walls may be configured to house the light source therebetween. With this configuration, it is possible to conduct most of the heat radially exited from the light source to the heat conduction walls to further enhance heat radiation performance of the light source.

The lighting device may further include a housing member made from metal and may be configured to house the light guide plate and the base, and a heat conduction sheet provided between the base and the housing member. With this configuration, a gap between the base and the housing member is filled with the heat conduction sheet, and therefore heat is smoothly conducted from the base to the housing member side. This further enhances radiation performance.

The light source may be a white light-emitting diode. With this configuration, it is possible to realize high brightness of the light source. Further, it is possible to suppress heat generated from the white light-emitting diode due to high radiation performance, and therefore it is possible to prevent degradation of the white light-emitting diode.

The white light-emitting diode may include a light-emitting chip configured to emit blue light, and a phosphor layer formed around the light-emitting chip and having an emission peak in a yellow region. With this configuration, it is possible to provide the white light-emitting diode with one chip. Also, the white light-emitting diode may include a light-emitting chip configured to emit blue light, and a phosphor layer formed around the light-emitting chip and having an emission peak in a green region and a red region. Also, the white light-emitting diode may include a light-emitting chip configured to emit blue light, a phosphor layer formed around the light-emitting chip and having an emission peak in a green region, and a light-emitting chip emitting a red light.

Also, the white light-emitting diode may include a light-emitting chip configured to emit blue light, a light-emitting chip emitting a green light, and a light-emitting chip configured to emit red light. With this configuration, a color tone is averaged as a whole, and therefore it is possible to obtain illumination light of substantially uniform color.

Further, the white light-emitting diode may include a light-emitting chip configured to emit ultraviolet light, and a phosphor layer formed around the light-emitting chip. In this configuration, the phosphor layer may preferably have an emission peak in a blue region, a green region and a red region. With this configuration, a color tone is averaged as a whole, and therefore it is possible to obtain illumination light of substantially uniform color.

The lighting device may further include an LED board on which the white light-emitting diodes are arranged in a line. With this configuration, white light-emitting diodes are collectively arranged in the housing member, and therefore excellent workability is obtained. Also, heat can be radiated through the LED board and therefore high heat radiation performance is obtained.

The lighting device may further include a fixing member tightly fixing the LED board to the attachment surface of the base. With this configuration, heat conduction from the LED board to the base is promoted, and therefore heat radiation performance is further enhanced.

Each of the heat conduction walls may be formed in a continuous elongate shape along a longitudinal direction of the LED board in a seamless manner. With this configuration, the LED board is surrounded by the heat conduction walls in a seamless manner. Therefore, uniform heat radiation performance is obtained over the entire length in the longitudinal direction of the LED board.

The heat conduction walls may form a gap therebetween ad the gap is set to just fit to a size of the LED board. With this configuration, it is possible to use the heat conduction walls in determining a position of the LED board (i.e. a position with respect to an end surface of the light guide plate). Also, an LED that is a heat generation source is extremely close to the heat conduction walls, and therefore the heat radiation performance of the LED is further enhanced.

The heat conduction sheet maybe formed in a continuous elongated shape along a longitudinal direction of the LED board in a seamless manner. With this configuration, heat is conducted from the base to the housing member side in a seamless manner, and therefore it is possible to obtain uniform heat radiation performance over the entire length in the longitudinal direction of the LED board.

The lighting device may further include a reflection member arranged on the LED board and configured to reflect light. This improves incidence efficiency of light that is emitted from a white light-emitting diode and enters the light guide plate. Also, the reflection member is preferably a reflection sheet (such as a foamed PET (polyethylene terephthalate) reflection sheet and a multilayer film reflection sheet) or a resist that reflects light.

Also, a display device of the present invention may have the above lighting device and a display panel that performs display using light from the lighting device. Further, the television receiver of the present technology may have the display device. Here, the display panel may be a liquid crystal panel. Such a display device is applicable to, for example, a display of a television or a personal computer, and is especially suitable for a large-size screen.

### ADVANTAGEOUS EFFECT OF THE INVENTION

According to the present invention, it is possible to provide a lighting device of higher heat radiation performance, a display device using the lighting device, and a television receiver.

### BRIEF DESCRIPTION OF THE DRAWINGS

FIG. 1 is an exploded perspective view illustrating a schematic configuration of a television receiver according to the first embodiment of the present invention;

FIG. 2 is an exploded perspective view illustrating a schematic configuration of a display device included in the television receiver;

FIG. 3 is a cross-sectional view illustrating the display device cut-away in the Y direction;

FIG. 4 is an enlarged view illustrating a part of FIG. 3;

FIG. 5 is a cross-sectional view illustrating the display device cut-away in the X direction;

FIG. 6 is a view illustrating a heat radiation path;

FIG. 7 is a view illustrating a configuration of an LED;

FIG. 8 is a cross-sectional view illustrating a display device according to the second embodiment of the present invention cut-away in the X direction;

FIG. 9 is a cross-sectional view illustrating a display device according to the third embodiment of the present invention cut-away in the X direction;

FIG. 10 is a cross-sectional view illustrating an attachment structure of an LED board (as an example using a screw);

FIG. 11 is a cross-sectional view illustrating an attachment structure of an LED board (as an example using a fixing claw);

FIG. 12 is a perspective view illustrating an LED board according to the fourth embodiment of the present invention;

FIG. 13 is an enlarged view illustrating a part of a cross-sectional surface of a display device cut-away in the Y direction;

FIG. 14 is a view illustrating a configuration of an LED according to the sixth embodiment of the present invention; and

FIG. 15 is a view illustrating a configuration of an LED according to the seventh embodiment of the present invention.

### BEST MODE FOR CARRYING OUT THE INVENTION

### First Embodiment

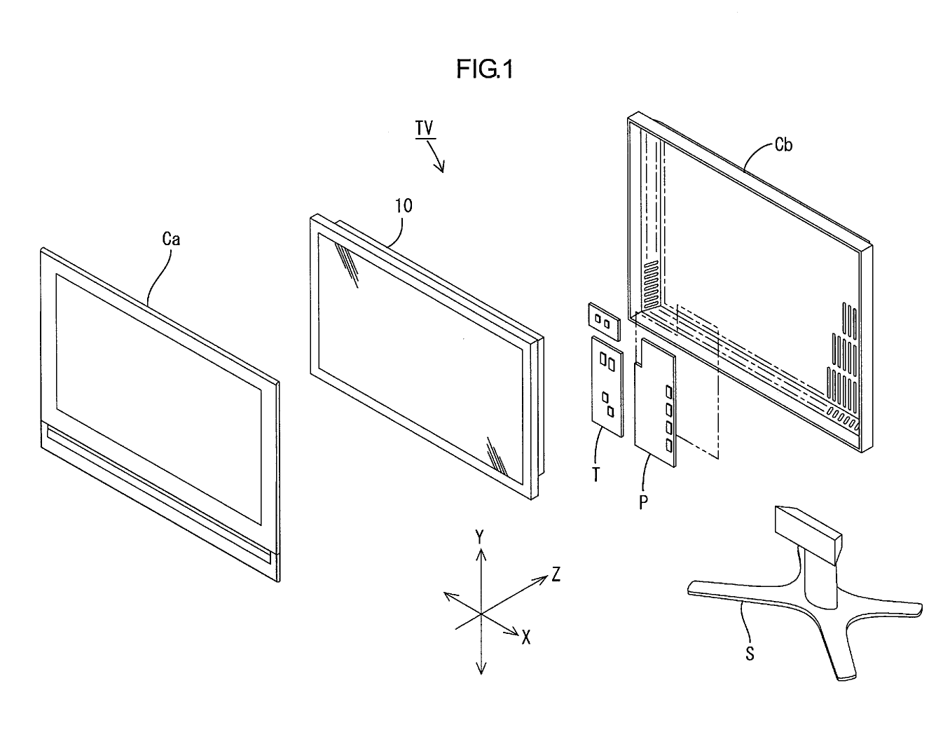

A first embodiment of the present invention will be explained with reference to FIGS. 1 to 7. As illustrated in FIG. 1, a television receiver TV according to the present embodiment has a display device 10, front and rear cabinets Ca and Cb housing the display device 10 so as to sandwich it between two cabinets, a power source P, a tuner T and a stand S.

The display device 10 has a horizontally-long rectangular shape as a whole. The display device 10 has a liquid crystal panel 11 as a display panel and a lighting device 21 as an external light source. Also, the following explanation will be given based on the assumption that: the horizontal direction (i.e. the longitudinal direction) of the display device 10 is the X direction; the height direction (i.e. the shorter direction) thereof is the Y direction; and the depth direction thereof is the Z direction.

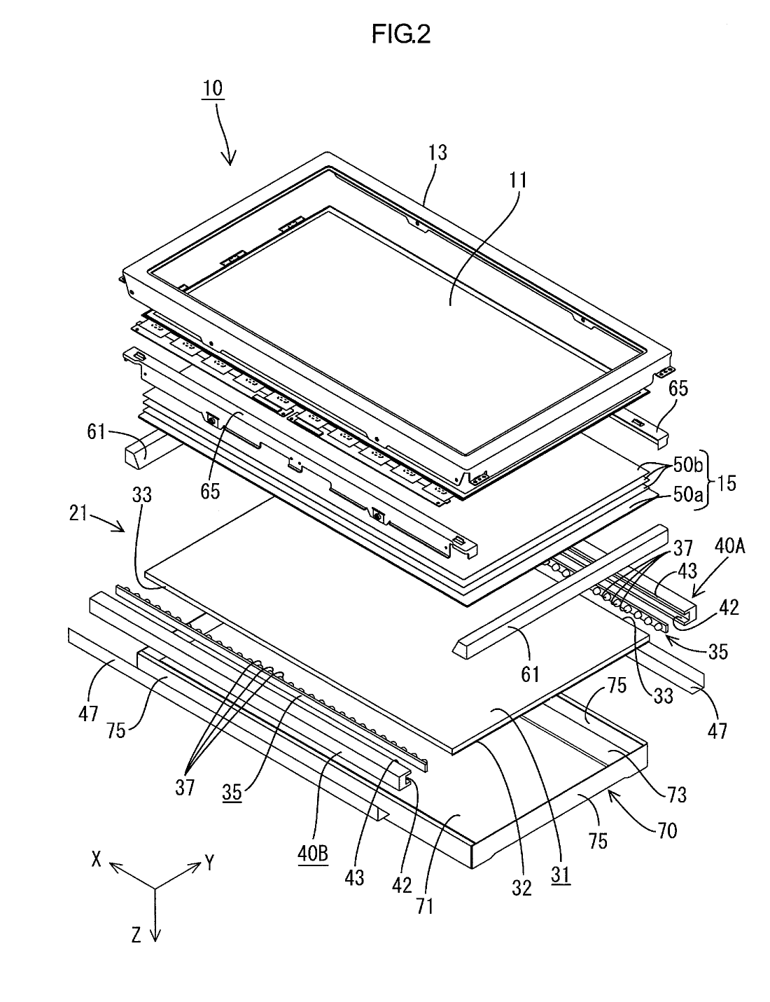

As illustrated in FIG. 2, the liquid crystal panel 11 has a horizontally-long rectangular shape. The liquid crystal panel 11 is configured to have a pair of glass substrates, which is attached to each other with a predetermined gap between and encloses a liquid crystal therein. One glass substrate has: a switching component (e.g. TFT) connected to a source wiring and a gate wiring that are orthogonal to each other; a pixel electrode connected to the switching component; and further an alignment film. And the other glass substrate has: a color filter with color sections such as R (red), G (green) and B (blue) arranged in a predetermined array; a counter electrode; and further an alignment film. Also, a polarizing plate is arranged outside the substrates.

The lighting device 21 includes a light guide plate 31, an LED board 35, a pair of bases 40A and 40B, an optical member 50, a pair of holders 61, a chassis 70 housing these (as an example of a “housing member”), and a pair of frames 65.

The chassis 70 is made of metal and has a horizontally-long rectangular shape. The chassis 70 is configured with a bottom plate 71 and a side plate 75 rising from the outer end of each side of the bottom plate 71 to have a shallow box shape opening toward a front surface side that corresponds to a display surface side. The central part of the bottom plate 71 is a flat surface. The central part 71 has the light guide plate 31.

The light guide plate 31 is formed with a resin of high transparency (such as acrylic) and in a horizontally-long rectangular shape that is substantially the same as that of the liquid crystal panel 11. The light guide plate 31 has a reflection sheet 32 on the side of a rear surface 31b. The light guide plate 31 is arranged in the central part of the bottom plate 71 with a front surface 31f thereof facing upward. Light makes incidence into end surfaces 33 (i.e. both end surfaces in the Y direction) of this light guide plate 31, light makes incidence.

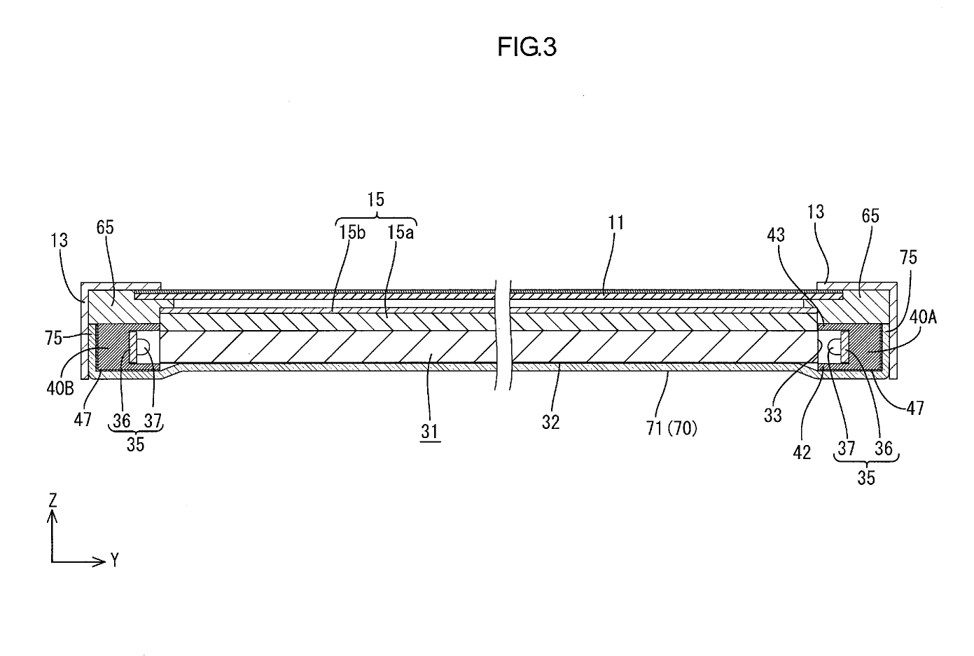

Meanwhile, both end parts 73 of the bottom plate 71 in the Y direction are lower than the central part, on which bases 40A and 40B are mounted. The bases 40A and 40B are made from metal such as an aluminum-based material same as the chassis 70 and in a column shape extending along the longitudinal direction of the light guide plate 31 (i.e. X direction). As illustrated in FIG. 3, the bases 40A and 40B face each other in the Y direction with the light guide plat 31 between.

Also, each side surface wall of the bases 40A and 40B (i.e. each side surface wall opposite to an end surfaces 33 of the light guide plate 31) is assigned as an attachment surface 41. And thereto, an LED board 35 is attached by adhesive with a light-emitting surface thereof facing the end surface 33 of the light guide plate 31.

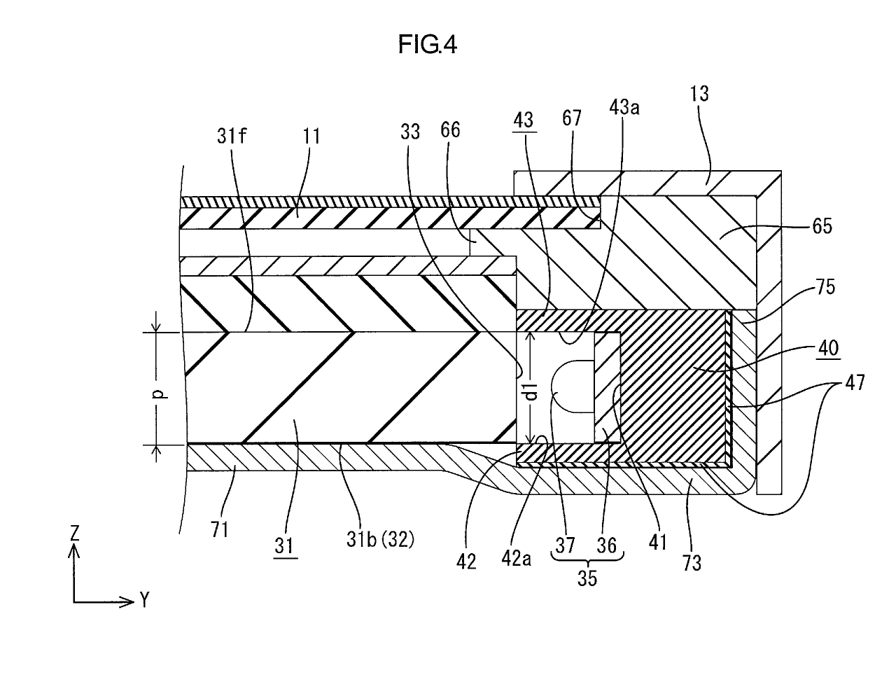

The LED board 35 is formed with a base member 36 and LEDs 37 (Light Emitting Diodes) mounted on the base member 36. The base member 36 is made from metal such as an aluminum-based material same as the chassis 70. And the base member 36 has a wiring pattern made from metal films (not illustrated) such as a copper foil on the front surface thereof across an insulating layer. As illustrated in FIG. 4, a width of the base member 36 is substantially the same as a thickness “d” of the light guide plate 31. The base member 36 is arranged in the front of the end surface 33 of the light guide plate 31. Further, the base member 36 extends along the longitudinal direction (i.e. X direction) of the light guide plate 31. On the front surface of the base member 36, LEDs 37 are arranged in a line at regular intervals.

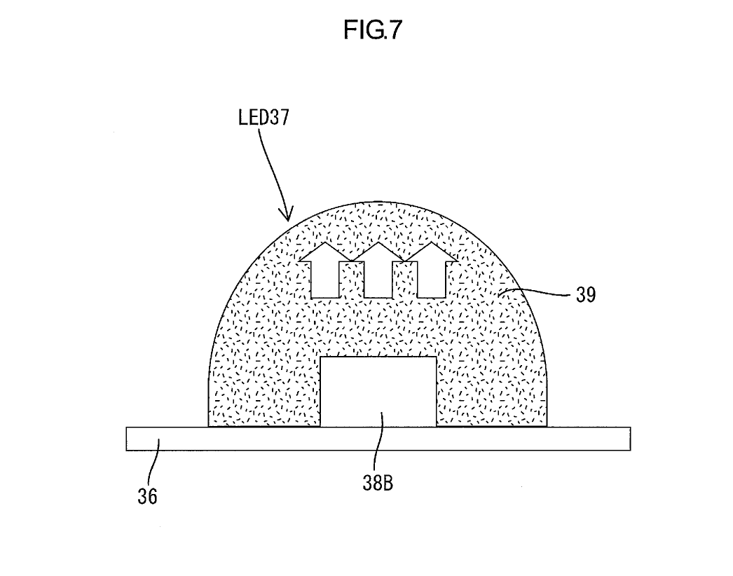

The LEDs 37 (as a one example of the “light source” of the present invention) are configured with a light-emitting chip 38B emitting a blue light and a phosphor layer 39 formed around the light-emitting chip 38B so as to cover it. The phosphor layer 39 is made from, for example, a transparent resin or a binder having fluorescent agent particles distributed therein, and has an emission peak in a region of yellow that is a complementary color of blue. When the light-emitting chip 38B emits light to excite the fluorescent agent particles, the phosphor layer 39 emits yellow light. Therefore, by mixing the blue color and the yellow color, the LEDs 37 emit white light (see FIG. 7).

From the above, when the LEDs 37 are driven (or turned on), the LEDs 37 emit white light. Then the light enters the end surface 33, and guided in the light guide plate 31 with reflecting at random. Finally, the light is reflected to the front surface 31f due to the reflection sheet 32 provided in the rear surface 31b of the light guide plate 31. By this configuration, strong light exits from the front surface 31f of the light guide plate 31 and the liquid crystal panel 11 is illuminated from the back surface side thereof. Thus, the lighting device 21 is a so-called edge-light-type lighting device 21.

On each attachment surface 41, heat conduction walls 42 and 43 are respectively formed on both sides (in FIG. 4, top and bottom sides) of the LED board 35. As illustrated in FIG. 4, the heat conduction walls 42 and 43 horizontally extend toward the end surface 33 of the light guide plate 31. Each of the distal ends of the heat conduction walls 42 and 43 is located far from the LEDs 37 to be on each end surface 33 of the light guide plate 31.

Also, an interval d1 between the heat conduction walls 42 and 43 is set to the minimum so as to house the LED board 35 with the minimum gap. For the relationship between the heat conduction walls 42 and 43 and the light guide plate 31, it is set such that: the interval dl between the heat conduction walls 42 and 43 is substantially equal to a thickness “d” of the light guide plate 31; an inner surface wall 42a of the heat conduction wall 42 continues onto the rear surface 31b of the light guide plate 31 without steps, and an inner surface wall 43a of the heat conduction wall 43 continues onto the front surface 31f of the light guide plate 31 without steps.

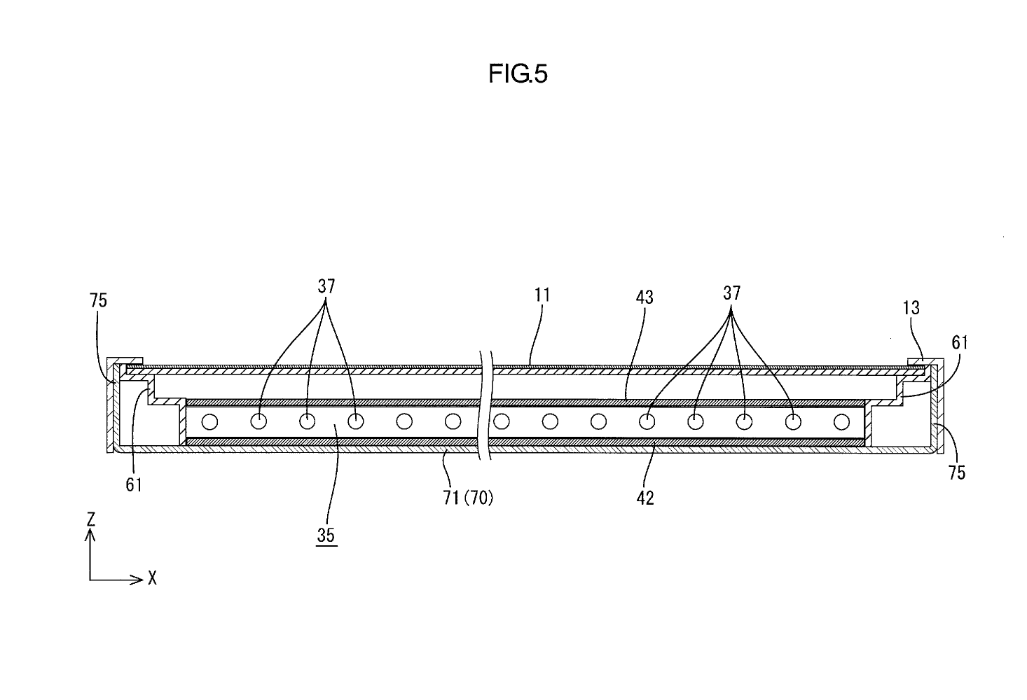

As illustrated in FIG. 5, the heat conduction walls 42 and 43 are continuously formed along the longitudinal direction of the LED board 35 on the attachment surface 41 to surround the entire length (i.e. the entire length in the X direction) of the LED board 35. No wall is provided on either end of the heat conduction wall 42 and 43 (i.e. an end in the X direction), and both sides of the LED board 35 in the X direction are open. These heat conduction walls 42 and 43 enhance heat radiation performance of the LEDs 37 by conducting heat generated in the LEDs 37 to the base 40 side.

Also, a heat conduction sheet 47 is provided between the base 40 and the chassis 70. The heat conduction sheet 47 is made by, for example, adding heat conductivity to an elastic material such as a rubber sheet of silicone series. As illustrated in FIG. 4, the heat conduction sheet 47 is arranged along two surfaces, that is, the end part 73 and the side plate 75 of the bottom plate 71 of the chassis 70, to fill up a joint part between the base 40 and the chassis 70 without gaps. This heat conduction sheet 47 is continuously formed over the entire length of the LED board 35 in seamless manners and adapted to conduct heat from the base 40 to the chassis 70.

Next, the optical member 50 has a horizontally-long rectangular shape similar to the liquid crystal panel 11, and is placed on the front surface side of the light guide plate 31. The optical member 50 is configured with a diffuser plate 50a and an optical sheet 50b. The diffuser plate 50a is configured with a base member made from a transparent resin having many diffusing particles distributed therein to diffuse transmitted light. The optical sheet 50b has a thinner sheet shape than the diffuser plate 50a. And two optical sheets 50b are arranged in a laminated manner. Examples of a specific kind of the optical sheet 50b include a diffuser sheet, a lens sheet and a reflection type polarizing sheet, and it is possible to properly select and use one of these.

The holder 61 is made from white synthetic resin, and as illustrated in FIG. 2, has an elongated substantially-box shape extending along the Y direction. The holder 61 is attached to the chassis 70 in the arrangement along the side plate 75 of the chassis 70. The holder 61 has a stepwise surface on which the optical member 50 and the liquid crystal panel 11 can be placed in different steps on the front surface side. The holder 61 supports marginal parts of the optical member 50 and the liquid crystal panel 11 in the X direction from the rear side of them.

As illustrated in FIG. 2, the frame 65 extends along the X direction and is attached to the upper surface side of the base 40 that is attached to the bottom surface of the chassis 70. This frame 65 has a flange 66 projecting inward to sandwich a marginal part of the optical member 50 in the Y direction between with the light guide plate 31.

Also, the frame 65 has a stepwise accepting part 67 on the upper surface to which the marginal part of the liquid panel 11 (i.e. marginal part in the Y direction) is fitted. Finally, by mounting a frame-shaped bezel 13 on the liquid crystal panel 11 from the front surface side thereof, the liquid panel 11 is integrally held with respect to the lighting device 21.

Next, effects of the present display device 10 will be explained.

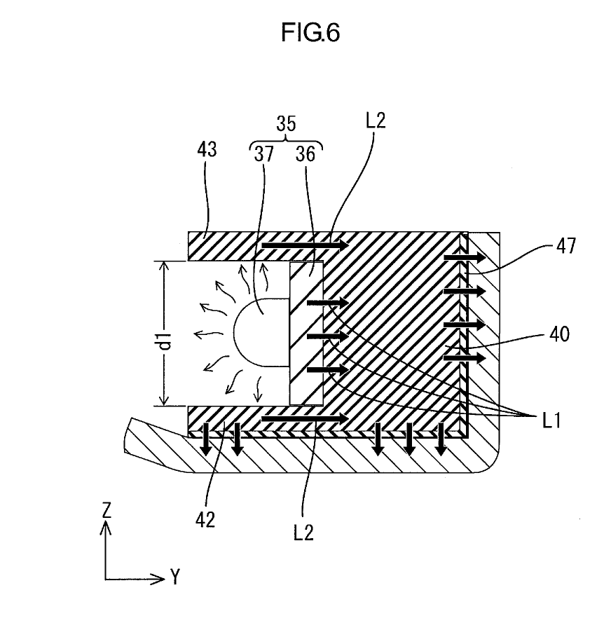

According to the present display device 10, heat generated from the LEDs 37 is conducted to the base 40 via two paths, that is, a first path L1 via the base member 36 and a second path L2 via the heat conduction walls 42 and 43, as illustrated in FIG. 6. Therefore, since high heat conductivity to the base 40 is obtained, it is possible to efficiently radiate heat generated in the LED board 35 via the base 40 and the chassis 70. Also, by providing the heat conduction walls 42 and 43, a heat radiation area of the base itself becomes wider to further enhance the heat radiation performance of the display device 10. From the above, a stable light is emitted from the LEDs 37, resulting in high image quality of the display device 10.

Also, the heat conduction walls 42 and 43 extend to the side of the end surface 33 of the light guide plate 31 over the positions of the LEDs 37 to house all the LEDs 37 inside the heat conduction walls 42 and 43. With this configuration, most of heat radially diffused from the LEDs 37 is conducted to the heat conduction walls 42 and 43, which enhances the heat radiation performance of the LED board 35.

Also, the heat conduction walls 42 and 43 continue along the longitudinal direction of the LED board 35, and surround the LED board 35 in seamless manners. With this configuration, it is possible to obtain uniform heat radiation performance over the longitudinal direction of the LED board 35.

Also, the heat conduction sheet 47 is inserted between the base 40 and the chassis 70. By this configuration, the heat conduction sheet 47 fills up a gap between the base 40 and the chassis 70 to enhance heat conductivity from the base 40 to the chassis 70. Therefore, the heat radiation performance of the LEDs 37 is further enhanced. Especially, this embodiment adopts a configuration in which the heat conduction sheet 47 continues in seamless manners along the longitudinal direction of the LED board 35. By this configuration, heat is conducted in seamless manner from the base 40 to the side of the chassis 70, resulting in uniform heat radiation performance over the entire length in the longitudinal direction of the LED board 35.

Also, the interval d1 between the heat conduction walls 42 and 43 is set to a size to house the LED board 35 without gaps. Therefore, the heat conduction walls 42 and 43 are used in determining a position of the LED board 35 (i.e. a position with respect to the end surface 33 of the light guide plate 31). Also, the distance between the LEDs 37 of heat generation sources and the heat conduction walls 42 and 43 are extremely close to further enhance the heat radiation performance of the LED board 35.

Also, the heat conduction walls 42 and 43 surround the laterals (in FIG. 4, top and bottom) of the LEDs 37. Therefore, light is diffused to the laterals after being output from the LEDs 37, is reflected to the heat conduction walls 42 and 43, and directs to the side of the light guide plate 31. Therefore, light which leaks to the outside conventionally makes incidence into the light guide plate 31, and therefore the light use efficiency is enhanced.

Also, in this embodiment, the LEDs 37 are used as a light source to realize high brightness of the light source. Further, the LEDs 37 are a one-chip type to reduce the size of the light source.

### Second Embodiment

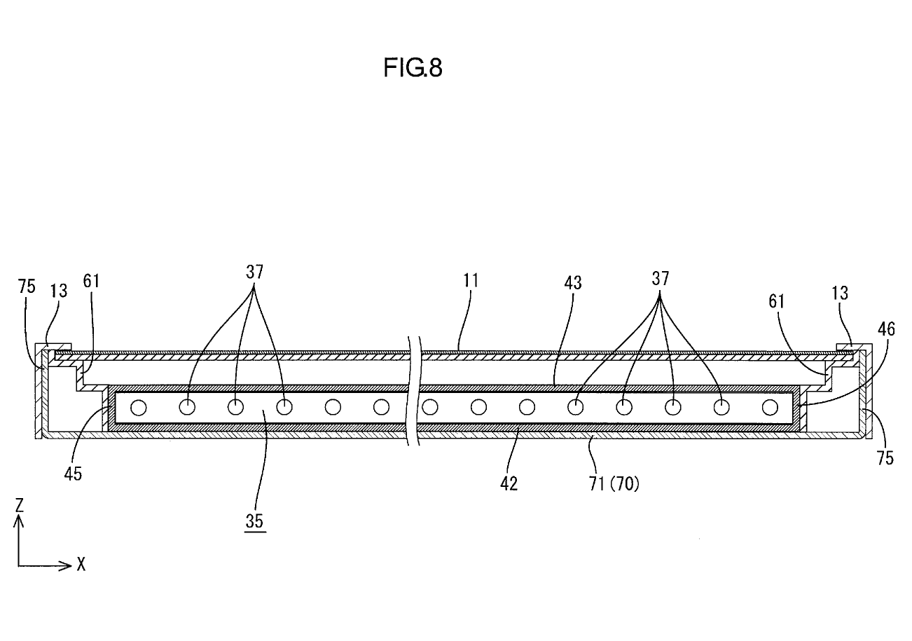

Next, a second embodiment of the present invention will be explained using FIG. 8. In the first embodiment, as illustrated in FIG. 5, the heat conduction walls 42 and 43 are respectively formed only in both sides (i.e. both sides in the Z direction) of the LED board 35, and both sides in the X direction of the LED board 35 are opened. In the second embodiment, as illustrated in FIG. 7, heat conduction walls 42, 43, 45 and 46 are respectively formed in four sides of the LED board 35 so as to surround the entire periphery of the LED board 35 by the heat conduction walls 42 to 46. With this configuration, in all peripheral directions around the LED board 35, heat is transferred from the LED board 35 to the heat conduction walls 42 to 46. Therefore, the heat radiation performance of the LED board 35 is further enhanced.

### Third Embodiment

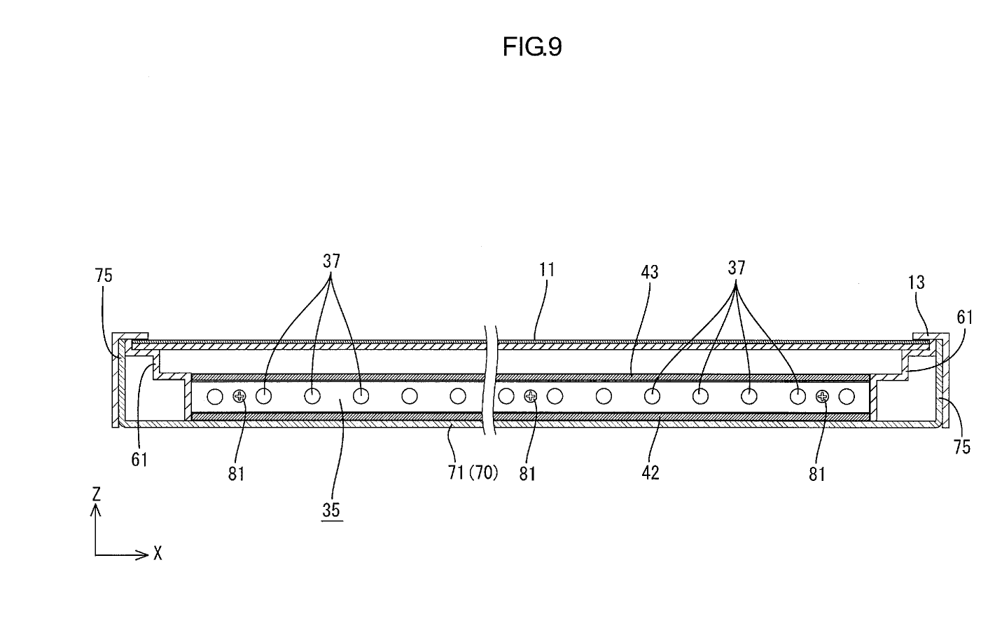

Next, a third embodiment of the present invention will be explained using FIG. 9 to FIG. 11. In the first embodiment, as an attachment configuration of the LED board 35 with respect to the bases 40A and 40B, an attachment configuration by adhesive is adopted. In the third embodiment, an attachment configuration of the LED board 35 with respect to the bases 40A and 40B is changed to a screw configuration using a screw 81 (which is an example of a “fixing member” of the present invention).

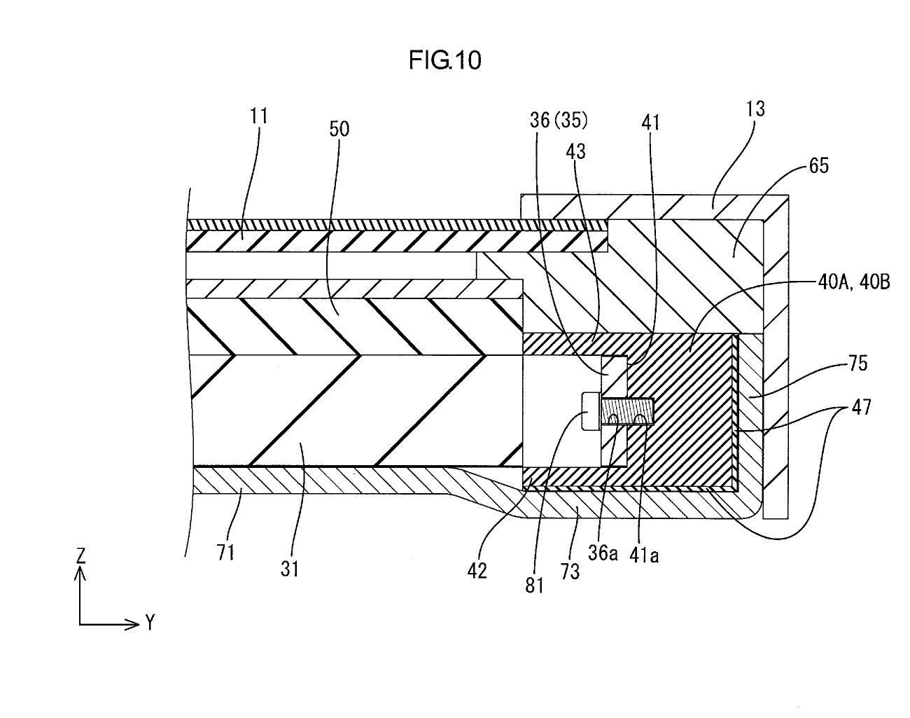

To be more specific, the base member 36 of the LED board 35 has screw through holes 36a at regular intervals along the longitudinal direction. Meanwhile, the attachment surfaces 41 of the bases 40A and 40B have screw holes 41a corresponding to the screw through holes 36a. From the above, by inserting the screw 81 through the screw through hole 36a and screwing it into the screw hole 41a, the LED board 35 is tightened to tightly fix to the attachment surfaces 41 of the bases 40A and 40B (FIGS. 9 and 10).

Thus, with a configuration of the LED board 35 fixed using the screw 81, the LED board 35 is adhered to the attachment surfaces 41 of the bases 40A and 40B. Therefore, heat conduction from the LED board 35 to the bases 40A and 40B is facilitated, and therefore heat radiation performance is further enhanced.

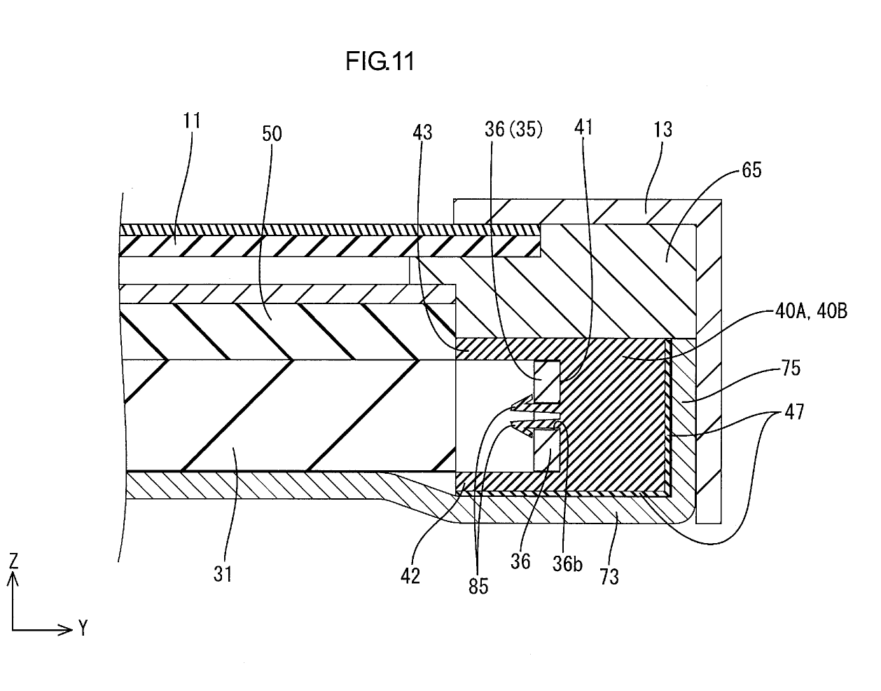

Here, for attaching the LED board 35 to the bases 40A and 40B, for example, as illustrated in FIG. 11, a fixing claw 85 (as an example of a “fixing member” of the present invention) that is bendable to the attachment surfaces 41 of the bases 40A and 40B may be provided. The fixing claw 85 locks in a locking hole 36b formed on the LED board 35. Even with this fixing method, the LED board 35 is adhered to the attachment surfaces 41 of the bases 40A and 40B, resulting in the same effect as in the case of fixation by the screw 81. Also, it is possible to adopt the fixing method using the screw 81 or the fixing claw 85 in combination with the fixing method using adhesive.

### Fourth Embodiment

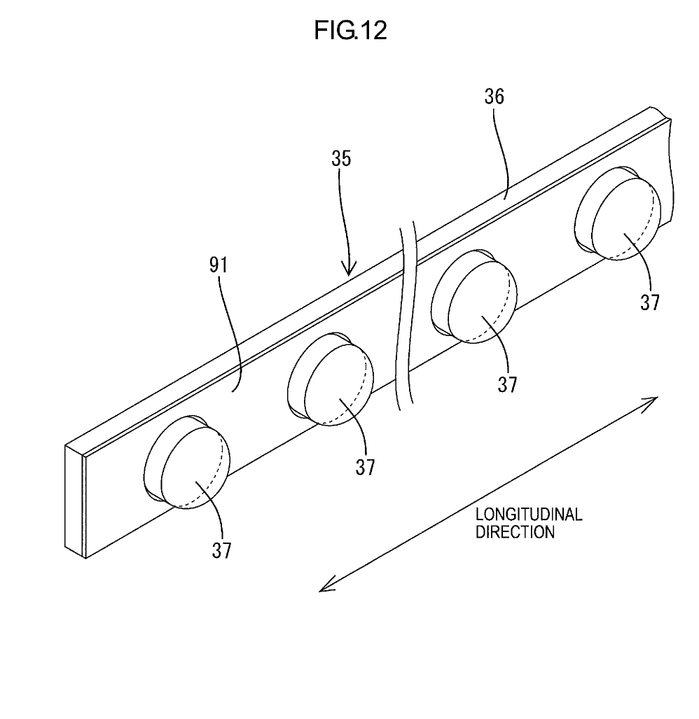

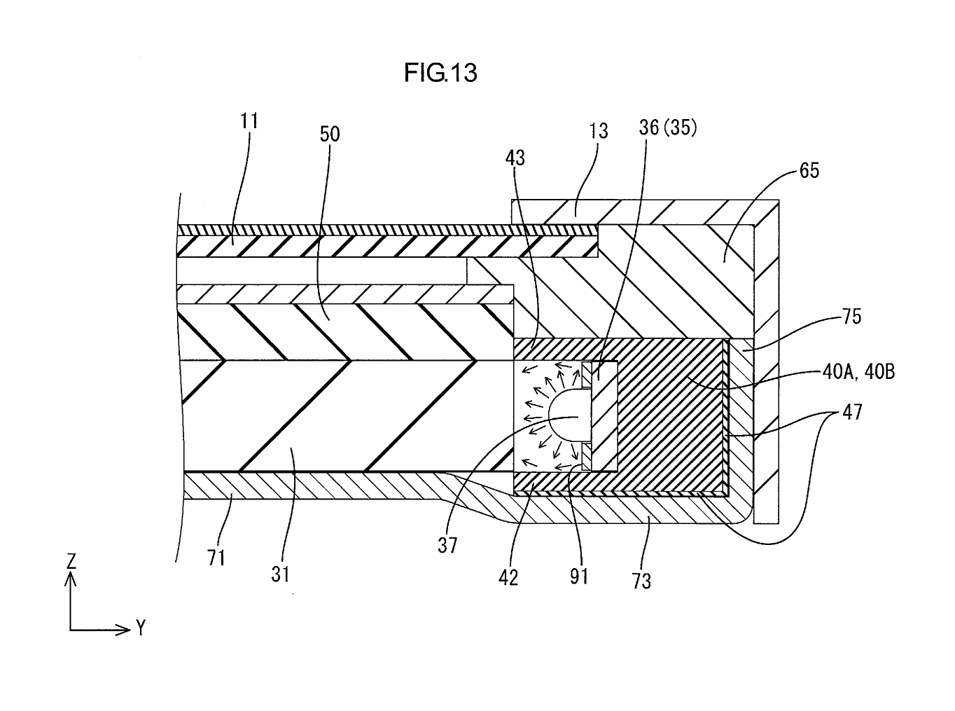

Next, a fourth embodiment of the present invention will be explained using FIGS. 12 and 13. In the fourth embodiment, a configuration of the LED board 35 is partly changed from that of the first embodiment. To be more specific, a reflection sheet 91 (as an example of a “reflection member” of the present invention) is arranged on the base member 36 of the LED board 35.

The reflection sheet 91 is formed over the entire length in the longitudinal direction of the base member 36 and covers a region except positions of the LEDs 37 in a base member front surface without gaps (see FIG. 12).

Also, the reflection sheet 91 may be a foamed PET) reflection sheet, a multilayer film reflection sheet and so on. The foamed PET reflection sheet is a reflection sheet using a white foamed PET as a resin base member. Also, the multilayer film reflection sheet or ESR (Enhanced Specular Reflector) is a reflection sheet having a high reflectance in a visible light range due to a multilayer film structure using a polyester resin.

The above reflection sheet 91 is configured to reflect light output from the LEDs 37 to the side of the light guide plate 31 (see FIG. 13). Therefore, an incidence efficiency of the light output from the LEDs 37 into the light guide plate 31 is enhanced.

### Fifth Embodiment

Next, a fifth embodiment of the present invention will be explained. In the first embodiment, the LEDs 37 are exemplified as a configuration including the phosphor layer 39 having an emission peak in a yellow region in combination with the light-emitting chip 38B that emits blue light. The LEDs 37 are applicable as long as they emit white light, and the following LEDs may be used.

The LEDs 37 are configured with the light-emitting chip 38B emitting blue light and the phosphor layer 39 formed around the light-emitting chip 38B. The phosphor layer 39 is made from a transparent resin or a binder including fluorescent agent particles, and has an emission peak in each of green and red regions. In this configuration, due to a combination of each color (blue, green and red), the LEDs 37 emit white light.

### Sixth Embodiment

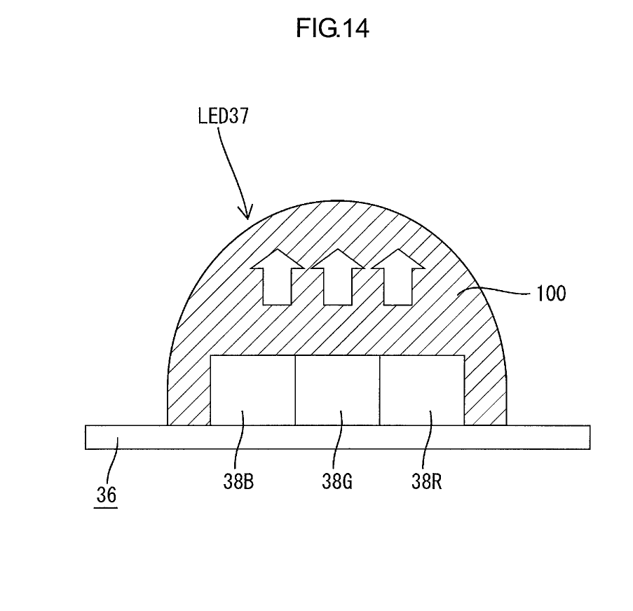

Next, a sixth embodiment of the present invention will be explained with reference to FIG. 14. In the first embodiment, the LEDs 37 are exemplified as a configuration including the phosphor layer 39 having an emission peak in a yellow region in combination with the light-emitting chip 38B emitting blue light. The LEDs 37 are applicable as long as they emit white light, and the following LEDs may be used.

As illustrated in FIG. 14, the LEDs 37 are formed with three light-emitting chips 38B, 38G and 39R arranged in a horizontal direction and a transparent resin 100 enclosing them. Three light-emitting chips 38B, 38G and 38R emit blue light, green light and red light, respectively. Accordingly, when three light-emitting chips 38B, 38G and 38R are turned on at the same time, three colors are mixed and the LEDs 37 emit white light.

### Seventh Embodiment

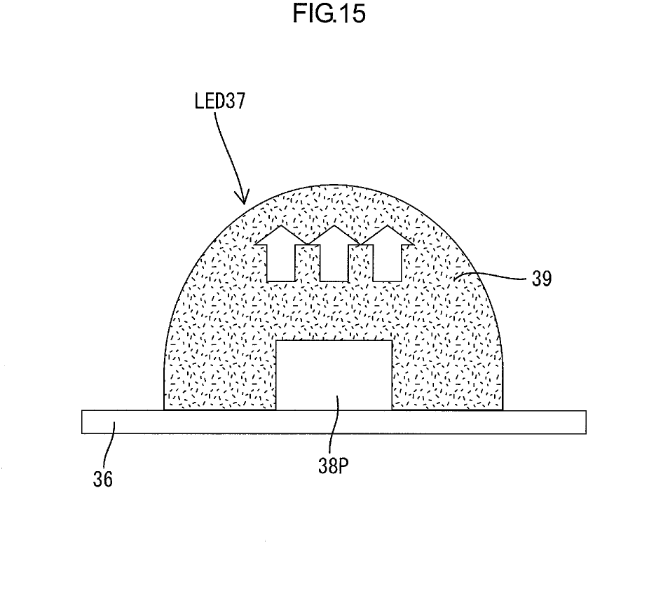

Next, a seventh embodiment of the present invention will be explained with reference to FIG. 15. In the first embodiment, the LEDs 37 are exemplified as a configuration including the phosphor layer 39 having an emission peak in a yellow region in combination with the light-emitting chip 38B emitting blue light. The LEDs 37 are applicable as long as they emit white light, and the following LEDs may be used.

The LEDs 37 are configured with a light-emitting chip 38P emitting ultraviolet light and the phosphor layer 39 formed around the light-emitting chip 38P so as to cover it (see FIG. 15). The phosphor layer 39 is made from a transparent resin or a binder having fluorescent agent particles distributed, and has an emission peak in a blue region, a green region and a red region respectively. With this configuration, when the light-emitting chip 38P emits light, fluorescent agent particles are excited, and thereby the phosphor layer 39 emits light of respective colors of blue, green and red. Therefore, due to mix of these three colors, the LEDs 37 emit white light.

### Other Embodiment

The present invention is not limited to the above embodiments explained in the above description and figures. The following embodiments may be included in the technical scope of the present invention, for example.

(1) Although the above embodiments illustrate LEDs of light-emitting elements as an example of a light source, it is also possible to use other kinds of light sources such as a cold cathode tube and an organic EL.

(2) Although the above embodiments illustrate, as an example, that the LED board 35 is arranged in both sides in the Y direction of the light guide plate 31, it is also possible to arrange the LED board 35 only in one side in the Y direction. Also, it is possible to arrange the LED board 35 in both sides or one side in the X direction.

(3) Although the above embodiments illustrate a longitudinal-shaped board over the entire length (i.e. the entire length in the X direction) of the light guide plate 31 as an example of the LED board 35, the LED board 35 does not necessarily have a longitudinal shape, and it is also possible to arrange reed-shaped LED boards 35 in a line. In this configuration, the heat conduction walls 42 and 43 may be arranged in accordance with each of the LED boards 35 arranged in a line.

(4) Although the above embodiments illustrate that TFT is used as a switching component of a display device (i.e. a liquid crystal display deice), the liquid crystal display device using other switching components (such as a thin-film diode (TFD)) than TFT is also applicable. In addition to a liquid crystal display device of color display, a liquid crystal display device of monochrome display is also applicable.

(5) Although the above embodiments illustrate an example of a liquid crystal display device using a liquid crystal panel as a display panel, the present invention is also applicable to a display device using a display panel of a different type.

(6) Although the above embodiments illustrate an example of a television receiver having a tuner, the present invention is also applicable to a display device without a tuner.

(7) Although the fourth embodiment illustrates a reflection sheet 91 (such as a foamed PET reflection sheet and a multilayer film reflection sheet) as an example of a “reflection member” of the present invention, instead of using the reflection sheet 91, it is also possible to apply a white solder mask including a high optical reflective material such as oxidized titanium, barium titanate and polycarbonate, onto the front surfaces of the base member 36 of the LED board 35. Here, in this case, it is possible to make the thickness thinner than the reflection sheet.

(8) The first embodiment illustrates, as an example of the LEDs 37, a configuration including the phosphor layer 39 having an emission peak in a yellow region in combination with the light-emitting chip 38B emitting blue light. The LEDs 37 are applicable as long as they emit white light, and the following LEDs can be used.

The LEDs 37 are configured with: the light-emitting chip 38B emitting blue light; the phosphor layer 39 formed around the light-emitting chip 38B and having an emission peak in a green region; and a light-emitting chip 38R emitting red light. With this configuration, due to mix of each color (blue, green and red), the LEDs 37 emit white light.

### EXPLANATION OF SYMBOLS

10 Display device

11 Liquid crystal panel

21 Lighting device

30 Light guide plate

33 End surface

35 LED board (which is an example of a “light source” of the present invention)

36 Base member

37 LED (which is an example of a “light source” of the present invention)

40 Base

41 Attachment surface

42, 43 Heat conduction wall

47 Heat conduction sheet

70 Chassis (as an example of a “housing body” of the present invention)

TV Television receiver

1. A lighting device comprising:
a light guide plate having an end surface as a light entrance surface;
a base having an attachment surface and provided such that the attachment surface faces the end surface of the light guide plate;
a light source having a light emitting surface and provided on the attachment surface of the base such that the light emitting surface faces the end surface of the light guide plate; and
a pair of heat conduction walls each of which is provided on either side of the light source and on the attachment surface of the base and configured to conduct heat generated from the light source to the base.

2. The lighting device according to claim 1, wherein each of the heat conduction walls projects from the base toward the light guide plate such that an end of each heat conduction walls is located far from the light source and the heat conduction walls are configured to house the light source therebetween.

3. The lighting device according to claim 1, further comprising:
a housing member made from metal and configured to house the light guide plate and the base therein; and
a heat conduction sheet provided between the base and the housing member.

4. The lighting device according to claim 1, wherein the light source is a white light-emitting diode.

5. The lighting device according to claim 4, wherein the white light-emitting diode includes:
a light-emitting chip configured to emit blue light; and
a phosphor layer formed around the light-emitting chip and having an emission peak in a yellow region.

6. The lighting device according to claim 4, wherein the white light-emitting diode includes:
a light-emitting chip configured to emit blue light; and
a phosphor layer formed around the light-emitting chip and having an emission peak in a green region and a red region.

7. The lighting device according to claim 4, wherein the white light-emitting diode includes:
a light-emitting chip configured to emit blue light;
a phosphor layer formed around the light-emitting chip and having an emission peak in a green region; and
a light-emitting chip configured to emit red light.

8. The lighting device according to claim 4, wherein the white light-emitting diode includes:
a light-emitting chip configured to emit blue light;
a light-emitting chip configured to emit green light; and
a light-emitting chip configured to emit red light.

9. The lighting device according to claim 4, wherein the white light-emitting diode includes:
a light-emitting chip configured to emit ultraviolet light; and
a phosphor layer formed around the light-emitting chip.

10. The lighting device according to claim 9, wherein the phosphor layer has an emission peak in a blue region, a green region and a red region.

11. The lighting device according to claim 4, further comprising an LED board on which the white light-emitting diodes are arranged in a line.

12. The lighting device according to claim 11, further comprising a fixing member configured to tightly fix the LED board to the attachment surface of the base.

13. The lighting device according to claim 11, wherein each of the heat conduction walls is formed in a continuous elongated shape along a longitudinal direction of the LED board in a seamless manner.

14. The lighting device according to claim 11, wherein the heat conduction walls form a gap therebetween and the gap is set to just fit to a size of the LED board.

15. The lighting device according to claim 11, wherein the heat conduction sheet is formed in a continuous elongated shape along a longitudinal direction of the LED board in a seamless manner.

16. The lighting device according to claim 11, further comprising a reflection member arranged on the LED board and configured to reflect light.

17. The lighting device according to claim 16, wherein the reflection member is a foamed PET reflection sheet.

18. The lighting device according to claim 16, wherein the reflection member is a multilayer film reflection sheet.

19. The lighting device according to claim 16, wherein the reflection member is a resist that reflects light.

20. A display device comprising:
the lighting device according to claim 1; and
a display panel performing display using light from the lighting device.

21. The display device according to claim 20, wherein the display panel is a liquid crystal panel formed by enclosing a liquid crystal between a pair of substrates.

22. A television receiver comprising the display device according to claim 20.
